(19) United States
(12) Patent Application Publication
(10) Pub. No.: US 2014/0267726 A1
(43) Pub. Date: Sep. 18, 2014

(54) VEHICLE APPROACHING DETECTOR AND NOTIFICATION

(71) Applicants: Yi Shy Lin, (US); Chung Huang Yu, (US)

(72) Inventor: Yi Shy LIN, Taichung (TW)

(73) Assignees: Chung Huang YU, Taichung (TW); Yi Shy LIN, Taichung (TW)

(21) Appl. No.: 13/802,888

(22) Filed: Mar. 14, 2013

(51) Int. Cl. G08G 1/16

(52) U.S. Cl. CPC G08G 1/167
USPC 348/148; 340/901

(57) ABSTRACT

A vehicle approaching detector and notification device includes a central processing device, a number of detectors attached to different portions of a vehicle and electrically connected to the central processing device for sending detecting signals to the central processing device, a number of vibration generating devices attached to a driver seat of the vehicle and electrically connected to the central processing device and actuated in corresponding to the detectors for generating a vibrating and warning signal in order to indicate different approaching direction and location or position of another vehicle.

### BACKGROUND OF THE INVENTION

1. Field of the Invention

The present invention relates to a vehicle detecting and/or warning device, and more particularly to a vehicle approaching detector and notification device for detecting the positions or spacing or directions of the other vehicles that approaching our vehicle from the outer peripheral portion of our vehicle, and for generating various or different warning signals to indicate and to warn the driver from which direction or position the other vehicles are approaching our vehicle.

2. Description of the Prior Art

Typical vehicle approaching detector and notification devices comprise a number of detectors disposed or attached or mounted or secured to the vehicle for detecting the positions or spacing or directions of the other vehicles that approaching our vehicle, and include a number of light generators or the like for generating various or different warning signals to indicate and to warn the driver that the other vehicles are approaching our vehicle.

The driver is often seen rotating his head or torso in an effort to gain intelligence about what competing vehicles are flanking his “blindsides”, and trying to manage the directional control of his vehicle, and the competing vehicle may occupy that area in the “blindside” (left, right or both sides, particularly the rear and side portions) not directly observable through the rear view mirror. The requirement to make an extraordinary inspection of the vehicle “blindside” is often exacerbated by the poor design utility of the vehicle itself.

For example, U.S. Pat. No. 4,694,295 to Miller et al., U.S. Pat. No. 6,347,266 to Kageyama, U.S. Pat. No. 7,394,355 to Sjonell, and U.S. Pat. No. 7,782,228 to Maxwell et al. disclose several of the typical vehicle approaching detector and notification devices each also comprising a number of detectors for detecting whether the other vehicles are approaching our vehicle or not, and a number of warning signal generating devices for generating various warning signals to indicate and to warn the driver that the other vehicles are approaching our vehicle.

However, while driving the vehicle, the driver should pay much attention to see or to view the warning signals in order to know whether the other vehicles are approaching our vehicle or not, and the driver may not know where or from which direction the other vehicles are approaching our vehicle, such that the driver also may not pay much attention to drive the vehicle.

The present invention has arisen to mitigate and/or obviate the afore-described disadvantages of the conventional vehicle approaching detector and notification devices.

### SUMMARY OF THE INVENTION

The primary objective of the present invention is to provide a vehicle approaching detector and notification device for detecting the positions or spacing or directions of the other vehicles that approaching our vehicle from the outer peripheral portion of our vehicle, and for generating various or different warning signals to indicate and to warn the driver from which direction or position the other vehicles are approaching our vehicle.

In accordance with one aspect of the invention, there is provided a vehicle approaching detector and notification device comprising a first vehicle including a driver seat, a control device including a central processing device, a first detector attached to a rear and right side portion of the first vehicle and electrically connected to the central processing device of the control device for sending detecting signals to the central processing device of the control device, a second detector attached to a right side portion of the first vehicle and electrically connected to the central processing device of the control device for sending detecting signals to the central processing device of the control device, a third detector attached to a rear and left side portion of the first vehicle and electrically connected to the central processing device of the control device for sending detecting signals to the central processing device of the control device, a fourth detector attached to a left side portion of the first vehicle and electrically connected to the central processing device of the control device for sending detecting signals to the central processing device of the control device, a first vibration generating device attached to a rear and right side portion of the driver seat of the first vehicle and electrically connected to the central processing device of the control device, a second vibration generating device attached to a right side portion of the driver seat of the first vehicle and electrically connected to the central processing device of the control device, a third vibration generating device attached to a rear and left side portion of the driver seat of the first vehicle and electrically connected to the central processing device of the control device, and a fourth vibration generating device attached to a left side portion of the driver seat of the first vehicle and electrically connected to the central processing device of the control device, and the first vibration generating device and the second vibration generating device and the third vibration generating device and the fourth vibration generating device being actuated in corresponding to the first detector and the second detector and the third detector and the fourth detector for generating a vibrating and warning signal in order to indicate an approaching direction and location of another vehicle.

The control device includes a sound generating device electrically connected to the central processing device for generating a sound and warning signal in corresponding to the first detector and the second detector and the third detector and the fourth detector respectively in order to indicate an approaching direction and location of another vehicle.

The sound generating device generates a first sound and a second sound and a third sound and a fourth sound in corresponding to the first detector and the second detector and the third detector and the fourth detector respectively in order to indicate different approaching direction and location of another vehicle. The first sound is Re, the second sound is Mi, the third sound is So, and the fourth sound is La.

The first vehicle includes a number of detectors attached to the first vehicle and electrically connected to the central processing device of the control device for sending detecting signals to the central processing device of the control device, and a number of vibration generating devices attached to the driver seat of the first vehicle and electrically connected to the central processing device of the control device and actuated in corresponding to the detectors for generating a vibrating and warning signal in order to indicate an approaching direction and location of another vehicle.

The first vehicle includes a first light generating device and a second light generating device and a third light generating device and a fourth light generating device electrically connected to the central processing device of the control device for generating a light signal in order to indicate an approaching direction and location of another vehicle.

The first vehicle includes a control panel, and the first light generating device and the second light generating device and the third light generating device and the fourth light generating device are disposed on the control panel. The first vehicle includes a number of camcorders, and a screen electrically connected to the camcorders for showing an image taken from the camcorders.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a vehicle including a vehicle approaching detector and notification device in accordance with the present invention;

FIG. 2 is a top plan schematic view of the vehicle having the vehicle approaching detector and notification device;

FIG. 3 is an enlarged partial top plan schematic view of the vehicle approaching detector and notification device;

FIG. 4 is a block diagram illustrating the parts or elements of the vehicle approaching detector and notification device; and

FIGS. 5, 6, 7 are top plan schematic views illustrating the operation of the vehicle approaching detector and notification device.

### DETAILED DESCRIPTION OF THE PREFERRED EMBODIMENT

Referring to the drawings, and initially to FIGS. 1-4, a vehicle approaching detector and notification device in accordance with the present invention comprises a number of detectors 11, 12, 13, 14, 15, 16, 17, 18 disposed or attached or mounted or secured to a first or now driving vehicle 10 at various or different directions or positions of the vehicle 10, for example, the detector 11 is optionally attached to the rear portion of the vehicle 10, the detector 12 is attached to the rear and right side portion of the vehicle 10, the detector 13 is attached to the right side portion of the vehicle 10, the detector 14 is attached to the front and right side portion of the vehicle 10, the detector 15 is attached to the rear and left side portion of the vehicle 10, the detector 16 is attached to the left side portion of the vehicle 10, the detector 17 is attached to the front and left side portion of the vehicle 10, and the detector 18 is attached to the front portion of the vehicle 10 and faced or directed toward the rear portion 20, the rear and right side portion 21, the right side portion 22, the front and right side portion 23, the rear and left side portion 24, the left side portion 25, the front and left side portion 26, and the front portion 27 of the vehicle 10 (FIG. 2).

Accordingly, the detectors 11-18 may be used to detect or sense the other objects or vehicles that are located or positioned or approached at various or different directions or positions of the first vehicle 10. As shown in FIG. 4, the vehicle approaching detector and notification device includes a control device 3 having a central processing unit or device 30 electrically connected or coupled to the detectors 11-18 for receiving and treating or processing the signals sensed or detected by the detectors 11-18, and includes a warning signal generating device 31, such as a light emitting diode or device, a speaker or the like, electrically connected or coupled to the central processing device 30 for generating various or different warning signals, such as warning lights, warning sounds or the like.

For example, as shown in FIG. 2, when another vehicle (not illustrated) is approaching or closing to the rear portion 20 of the vehicle 10, the speaker or the signal generating device 31 may generate a sound, such as Do, and may generate another different sound, such as Re when another vehicle 90 is approaching or closing to the rear and right side portion 21 of the vehicle 10 (FIG. 7), and may generate a further different sound, such as Mi when the other vehicle 90 is approaching or closing to the right side portion 22 of the vehicle 10 (FIG. 5), and may generate a further different sound, such as Fa when the other vehicle (not illustrated) is approaching or closing to the front and right side portion 23 of the vehicle 10, and may generate the other different sound, such as So when the other vehicle 90 is approaching or closing to the rear and left side portion 24 of the vehicle 10 (FIG. 6), and may generate the other different sound, such as La, Si, Do when the other vehicle (not illustrated) is approaching or closing to the left side portion 25, the front and left side portion 26 or the front portion 27 of the vehicle 10.

Accordingly, the speaker or the signal generating device 31 may generate the sound, such as Do, Re, Mi, Fa, So, La, Si, Do when the other vehicle 90 is approaching or closing to various or different directions or positions of the vehicle 10, and the driver may know from which direction or position, such as the rear portion 20, the rear and right side portion 21, the right side portion 22, the front and right side portion 23, the rear and left side portion 24, the left side portion 25, the front and left side portion 26, and the front portion 27 of the vehicle 10 (FIG. 2) that the other vehicle 90 is approaching or closing to the vehicle 10, by hearing the different sounds, without paying much attention to see or to view the warning signals.

As shown in FIGS. 3 and 4, the vehicle approaching detector and notification device further includes a driver seat 40 disposed or attached or mounted or secured in the vehicle 10, and a number of vibrating or vibration generating devices 41, 42, 43, 44, 45, 46, 47, 48 disposed or attached or mounted or secured to the driver seat 40 at various or different directions or positions or locations, such as the rear portion, the rear and right side portion, the right side portion, the front and right side portion, the rear and left side portion, the left side portion, the front and left side portion, and the front portion of the driver seat 40 and actuated in corresponding to the detectors 11-18 at the rear portion 20, the rear and right side portion 21, the right side portion 22, the front and right side portion 23, the rear and left side portion 24, the left side portion 25, the front and left side portion 26, and the front portion 27 of the vehicle 10 respectively.

As shown in FIG. 4, the vibrating or vibration generating devices 41-48 are electrically connected or coupled to the central processing device 30 for generating vibrations or vibrating or warning signals in order to indicate and to warn the driver that the other vehicles are approaching our vehicle 10 from which directions or positions or locations. For example, when the other vehicle 90 is approaching or closing to the right side portion 22 of the vehicle 10 (FIG. 5), and the vibrating or vibration generating device 43 may generate a vibrating or vibration to indicate and to warn that the other vehicle 90 is approaching or closing to the right side portion 22 of the vehicle 10, and similarly, the other vibrating or vibration generating devices 41-42, 44-48 may generate a vibrating or vibration to indicate and to warn that the other vehicle 90 is approaching or closing to the other direction or position or location of the vehicle 10.

As also shown in FIGS. 3 and 4, the vehicle approaching detector and notification device further includes a number of light emitting diodes or light generating devices 51, 52, 53, 54, 55, 56, 57, 58 disposed or attached or mounted or secured in a selected or predetermined or suitable area 50 of a control panel 5 of the vehicle 10, and electrically connected or coupled to the central processing device 30 for generating lights or warning signals in order to indicate and to warn the driver that the other vehicles are approaching our vehicle 10 from which directions or positions or locations. The arrangement or the relative directions or relative positions or relative locations of the light generating devices 51-58 are disposed or attached or mounted or secured or arranged in relation to or corresponding to that of the detectors 11-18 relative to the vehicle 10.

As shown in FIG. 2, the vehicle approaching detector and notification device further includes a number of cameras or camcorders 61, 62, 63, 65, 66 disposed or attached or mounted or secured to the vehicle 10 at various or different directions or positions of the vehicle 10, such as the rear portion 20, the rear and right side portion 21, the right side portion 22, the rear and left side portion 24, the left side portion 25 of the vehicle 10 where the driver may not easily seen; and a monitor or screen 70 also disposed or attached or mounted or secured in a selected or predetermined or suitable area of the control panel 5 of the vehicle 10, and electrically connected or coupled to the camcorders 61-63, 65-66, and the screen 70 includes a number of portions or segments 71, 72, 73, 75, 76 for showing the images or videos taken from the camcorders 61-63, 65-66 respectively.

In operation, as shown in FIGS. 3-4, the vibrating or vibration generating devices 41-48 may be provided for generating vibrations or vibrating or warning signals in order to indicate and to warn the driver from which directions or positions or locations that the other vehicles approaching or closing to the vehicle 10, such that the driver may know the directions or positions or locations of the other vehicles 90 that approaching or closing to the vehicle 10 without paying much attention to see or to view the warning signals, and such that the driver may pay full attention to drive the vehicle 10. As shown in FIGS. 2 and 4-7, the speaker or the signal generating device 31 may generate different sounds, such as Do, Re, Mi, Fa, So, La, Si, Do to indicate the direction or location where the other vehicle 90 is approaching or closing to the vehicle 10, and the light generating devices 51-58 may further be used to generate light signals and to indicate the approaching directions or positions or locations of the other vehicle 90.

It is to be noted that the “blindspots” or the “blindsides”, particularly the left side, the right side or both sides, and the rear and side portions may not be directly observable by the driver, and such that the first detector 12 attached to the rear and right side portion of the vehicle 10 and the first vibration generating device 42, the second detector 13 attached to the right side portion of the vehicle 10 and the second vibration generating device 43, the third detector 15 attached to the rear and left side portion of the vehicle 10 and the third vibration generating device 45, and the fourth detector 16 attached to the left side portion of the vehicle 10 and the fourth vibration generating device 46 will be the most important detectors are required to be provided or disposed or engaged or attached to the vehicle 10.

Accordingly, the vehicle approaching detector and notification device in accordance with the present invention may be provided for detecting the positions or spacing or directions of the other vehicles that approaching our vehicle from the outer peripheral portion of our vehicle, and for generating various or different warning signals to indicate and to warn the driver from which direction or position the other vehicles are approaching our vehicle.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A vehicle approaching detector and notification device comprising:
a first vehicle including a driver seat,
a control device including a central processing device,
a first detector attached to a rear and right side portion of said first vehicle and electrically connected to said central processing device of said control device for sending detecting signals to said central processing device of said control device,
a second detector attached to a right side portion of said first vehicle and electrically connected to said central processing device of said control device for sending detecting signals to said central processing device of said control device,
a third detector attached to a rear and left side portion of said first vehicle and electrically connected to said central processing device of said control device for sending detecting signals to said central processing device of said control device,
a fourth detector attached to a left side portion of said first vehicle and electrically connected to said central processing device of said control device for sending detecting signals to said central processing device of said control device,
a first vibration generating device attached to a rear and right side portion of said driver seat of said first vehicle and electrically connected to said central processing device of said control device,
a second vibration generating device attached to a right side portion of said driver seat of said first vehicle and electrically connected to said central processing device of said control device,
a third vibration generating device attached to a rear and left side portion of said driver seat of said first vehicle and electrically connected to said central processing device of said control device, and
a fourth vibration generating device attached to a left side portion of said driver seat of said first vehicle and electrically connected to said central processing device of said control device, and
said first vibration generating device and said second vibration generating device and said third vibration generating device and said fourth vibration generating device being actuated in corresponding to said first detector and said second detector and said third detector and said fourth detector for generating a vibrating and warning signal in order to indicate an approaching direction and location of another vehicle.

2. The vehicle approaching detector and notification device as claimed in claim 1, wherein said control device includes a sound generating device electrically connected to said central processing device for generating a sound and warning signal in corresponding to said first detector and said second detector and said third detector and said fourth detector respectively in order to indicate an approaching direction and location of another vehicle.

3. The vehicle approaching detector and notification device as claimed in claim 2, wherein said sound generating device generates a first sound and a second sound and a third sound and a fourth sound in corresponding to said first detector and said second detector and said third detector and said fourth detector respectively in order to indicate different approaching direction and location of another vehicle.

4. The vehicle approaching detector and notification device as claimed in claim 3, wherein said first sound is Re, said second sound is Mi, said third sound is So, and said fourth sound is La.

5. The vehicle approaching detector and notification device as claimed in claim 1 further comprising a plurality of detectors attached to said first vehicle and electrically connected to said central processing device of said control device for sending detecting signals to said central processing device of said control device, and a plurality of vibration generating devices attached to said driver seat of said first vehicle and electrically connected to said central processing device of said control device and actuated in corresponding to said detectors for generating a vibrating and warning signal in order to indicate an approaching direction and location of another vehicle.

6. The vehicle approaching detector and notification device as claimed in claim 1, wherein said first vehicle includes a first light generating device and a second light generating device and a third light generating device and a fourth light generating device electrically connected to said central processing device of said control device for generating a light signal in order to indicate an approaching direction and location of another vehicle.

7. The vehicle approaching detector and notification device as claimed in claim 6, wherein said first vehicle includes a control panel, and said first light generating device and said second light generating device and said third light generating device and said fourth light generating device are disposed on said control panel.

8. The vehicle approaching detector and notification device as claimed in claim 1, wherein said first vehicle includes a plurality of camcorders, and a screen electrically connected to said camcorders for showing an image taken from said camcorders.
